(19) United States
(12) Patent Application Publication
(10) Pub. No.: US 2008/0229541 A1
(43) Pub. Date: Sep. 25, 2008

(54) End Cap

(75) Inventor: Horst Tillmann, Ennepetal (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GbbH +Co. KG, Ennepetal (DE)

(21) Appl. No.: 10/586,079

(22) PCT Filed: Jan. 18, 2005
(86) PCT No.: PCT/EP05/00440

§ 371 Date: Jul. 14, 2006

(30) Foreign Application Priority Data
Jan. 21, 2004 (DE) 10 2004 003 281.5

(51) Int. Cl. E05F 3/22; E05F 1/00

(52) U.S. Cl. 16/71

(57) ABSTRACT

An end cover for a housing of a door closer, comprising a cover housing. The cover housing includes a convexly curved end wall, two opposite convexly curved lateral walls coupled to each other by the end wall, and a flat covering wall connected to the end wall and the lateral walls. The end cover also includes an attachment device supported by the cover housing.

The invention relates to an end cap for a housing of a door closer according to the generic part of patent claim 1.

An end cap according to the generic part of patent claim 1 consists of a plate-shaped cap housing which is formed flat and is mounted on the open end surfaces of the door closer's housing, as such housings usually have a rectangular cross-section.

However, the structure of such constructions is relatively heavy and therefore, for visual reasons, a drawback when used with stylish door constructions.

Therefore, it is an object of the present invention to provide an end cap of the type indicated in the generic part of patent claim 1, the cap housing thereof allowing to create a visually more appealing door closer housing form.

This object is solved by the features of patent claim 1.

As an advantage resulting therefrom, a housing of a door closer equipped with the inventive end cap will have an overall slimmer and a more stylish conception, which is applicable to a plurality of door constructions in a visually advantageous manner.

Advantageous further developments of the invention are set forth in the dependent claims.

Hereinafter, embodiments of the invention will be explained based on the drawings, in which:

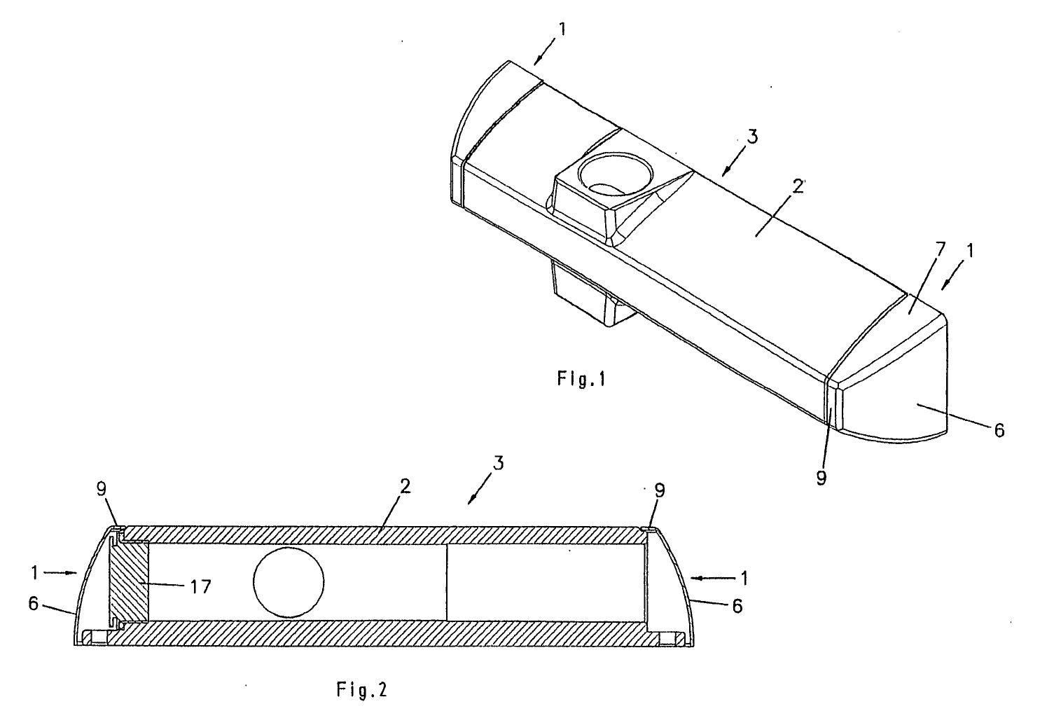

FIG. 1 shows a perspective, slightly simplified illustration of a door closer, the housing thereof being provided with one inventive end cap respectively at the end sides,

FIG. 2 shows a sectional illustration of the door closer according to FIG. 1,

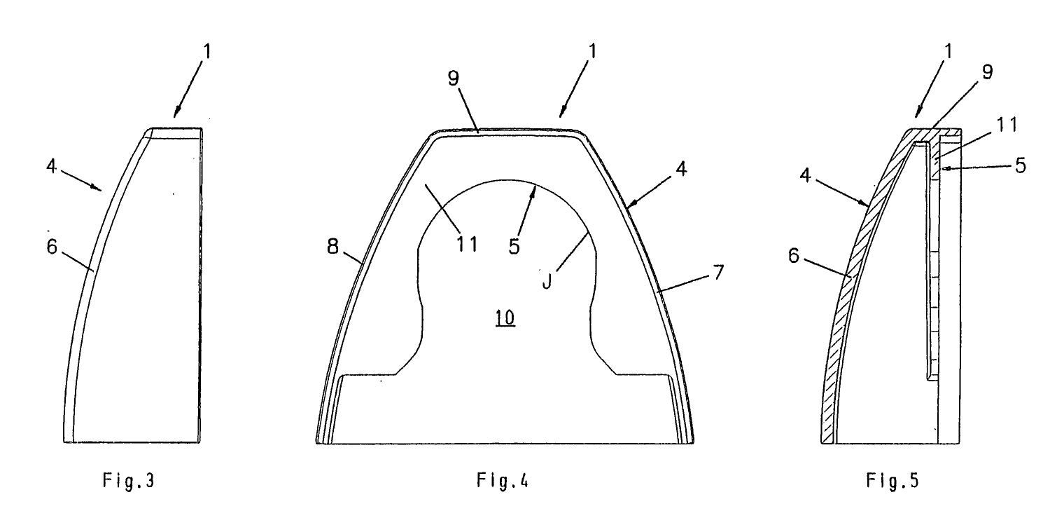

FIG. 3 shows a side elevation of a first embodiment of an inventive end cap,

FIG. 4 shows an inside view of a cap housing of the end cap according to FIG. 1,

FIG. 5 shows a sectional illustration of the end cap according to FIGS. 3 and 4,

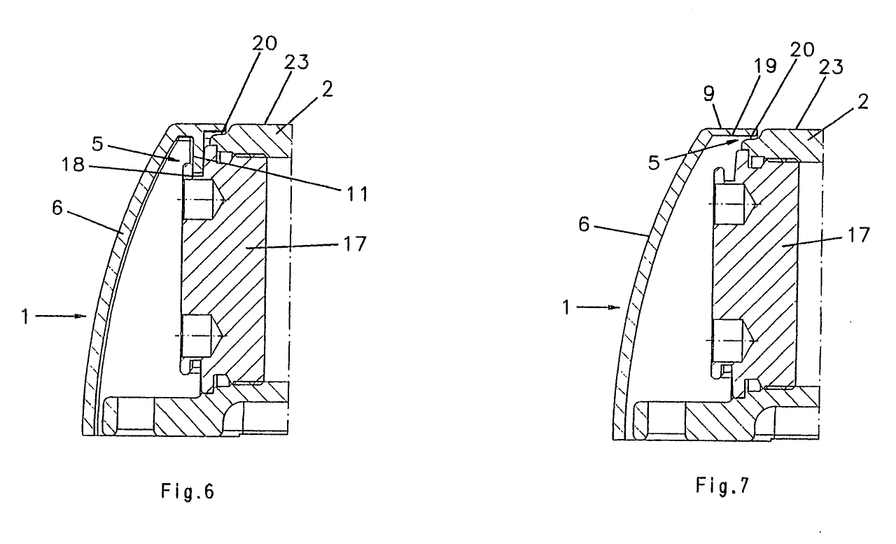

FIG. 6 shows a sectional illustration of an end area of the door closer according to FIG. 1, the end cap being mounted,

FIG. 7 shows an illustration of the door closer, corresponding to FIG. 6, in an alternative embodiment of the inventive end cap, and

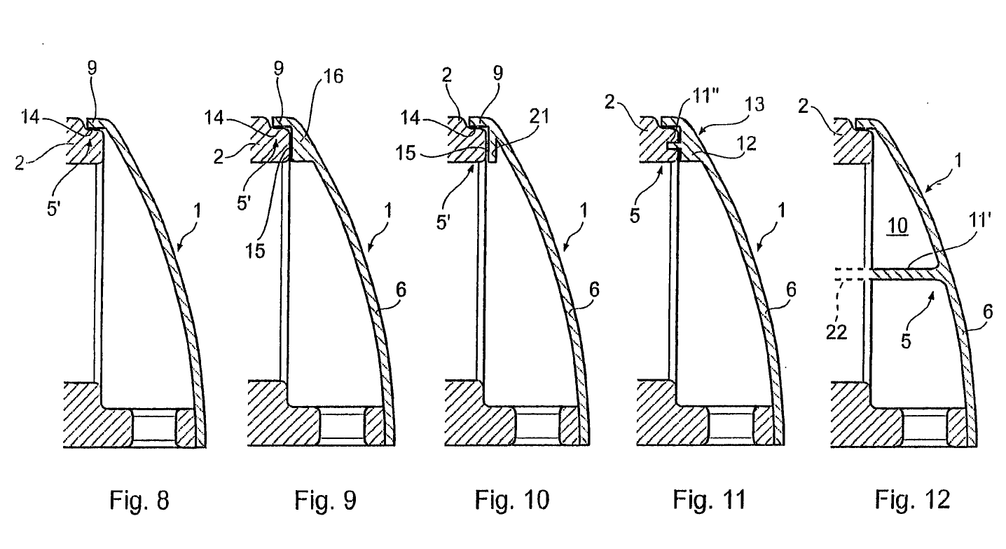

FIGS. 8-12 are illustrations corresponding to FIGS. 6 and 7 of further embodiments of the inventive end cap.

According to FIG. 1 a door closer 3 is illustrated which has a housing 2. As depicted in FIG. 1, the end sides of the door closer's 3 housing 2 are provided with one end cap 1 respectively. When combining the views of FIGS. 1 and 2, it is illustrated in this case that the end caps 1 are suitably connected to the housing 2 of the door closer 3, as will be explained hereinafter.

Hereinafter, a first embodiment of an inventive end cap 1 will be explained in detail based on FIGS. 3 to 5.

The end cap 1 has a cap housing 4, which, according to the illustration in FIG. 4, is provided with an attachment device 5.

FIGS. 3 and 5 show that the cap housing 4 has a convexly curved end wall 6.

Furthermore, FIG. 4 reveals that, in the illustrated embodiment, the cap housing 4 further has two convexly curved lateral walls 7 and 8. The combined view of FIGS. 3 to 5 shows that this convex shape of said walls results in a very stylish and slim embodiment of the cap housing 4.

In the embodiment illustrated in FIGS. 3 to 5, the cap housing 4 moreover has a covering wall 9, which is disposed at the top, is flat and integrally connected to the end wall 6 and the lateral walls 7 and 8. As a result, the cap housing 4 has a form which is particularly easy to manufacture.

Furthermore, FIGS. 4 and 5 reveal that in this example the attachment device 5 is formed as an insert connection, which attachment device 5, in the embodiment illustrated in FIGS. 3 to 5, has an insert flange 11. Starting at the covering wall 9, the insert flange 11 protrudes into the inner space 10 of the cap housing and has an inside contour I, the shape thereof matching the corresponding counter-surface of the housing 2 of the door closer 3. It is explicitly referred to the illustration in FIG. 4 where the inside contour I is disclosed. FIGS. 4 and 5 reveal in this case that in the illustrated embodiment the insert flange 11 is integrally connected to the covering wall 9.

FIG. 6 represents an enlarged illustration of the left end cap 1 of FIG. 2 in order to explain how this embodiment is attached at the housing 2. FIG. 6 shows in this case, that a screw plug 17, having a retaining slot 18, is mounted in the opening of the housing 2. The insert flange 11 of the attachment device 5 of the end cap 1 will engage in this retaining slot 18, thus reliably fixing the end cap 1 at the housing 2 without the risk of loosing it and allowing that it be removed as well.

FIGS. 6 and 7 further reveal that in the area of the surface 19, a counter-surface 20 is provided, which in relation to an outer contour 23 of the housing 2 is recessed by at least the thickness of the wall of the covering wall 9 of the end cap 1. This offset in the outside housing contour of the housing 2 achieves a seamless transition between the housing 2 and the end cap 1. Thus, projecting butt joints in the transition area between the end cap 1 and the beginning of the housing 2 are eliminated. At the same time an effective tolerance compensation is provided to compensate for manufacturing tolerances of both the housing 2 and the end caps 1. Furthermore, a visible gap between the end cap 1 and housing 2 is eliminated.

FIG. 7 represents an enlarged illustration of the right end cap according to FIG. 2. This embodiment has an alternative attachment device 5′ that is formed as an adherend 19 on the underside of the covering wall 9. This adherend 19 is glued to the corresponding counter-surface 20 of the housing 2 by means of a suitable adhesive, which is apparent from the diagrammatically simplified illustration in FIG. 7.

Further embodiments of the end cap 1 are illustrated in FIGS. 8 to 12, which include alternatives for the structure of the attachment device 5 or 5′.

In this case, FIGS. 8 to 10 show an attachment device 5′ which in the case of FIG. 8 has a single inside adherend 14 at the covering wall 9. This illustration substantially corresponds to the one of FIG. 7.

In FIGS. 9 and 10 an attachment device 5′ is provided, which has two adherends 14 and 15, which are substantially disposed at a right angle to each other. In the embodiment of FIG. 9, the adherend 14 is disposed at the inside of the covering wall 9 and the adherend 15 is disposed at a transition portion 16 between the end wall 6 and the covering wall 9. In this case, the transition portion 16 is formed as a thickened wall section of the end wall 6.

In the embodiment according to FIG. 10, the adherend 14 is again disposed at the inside of the covering wall 9, and the adherend 15 is disposed at a web 21, which extends at a right angle in relation to the adherend 14 and is integrally connected to the upper end area of the end wall 6.

In FIG. 11, an attachment device 5 is provided again in the shape of an insert connection. In this embodiment, an insert flange 11″ is integrally disposed at a contact section 12 of the covering wall 6. In this case, the contact section 12 is disposed in a transition area 13 between the end wall 6 and the covering wall 9.

In the embodiment of FIG. 12, the attachment device 5 is formed as an insert connection as well. In this case, an insert flange 11′ is provided, which is integrally disposed at the inside of the covering wall 6, in the central area thereof. As clearly revealed in FIG. 12, the insert flange 11′ projects into the inner chamber 10 and thus can be brought into engagement with an engagement opening 22, illustrated by a broken line in FIG. 12.

### LIST OF REFERENCE NUMERALS

1 end cap
2 housing
3 door closer
4 cap housing
5, 5′ attachment device
6 end wall
7, 8 lateral walls
9 covering wall
10 inner chamber
11, 11′, 11″ insert flange
12 contact section
13 transition area
14, 15 adherend
16 transition section
17 screw plug
18 slot
19 adherend
20 counter-surface
21 web
22 engagement opening
23 outer contour
I inner contour

1.-10. (canceled)

11. An end cover for a housing of a door closer, comprising:
a cover housing comprising:
a convexly curved end wall;
two opposite convexly curved lateral walls coupled to each other by the end wall; and
a flat covering wall connected to the end wall and the lateral walls; and
an attachment device supported by the cover housing.

12. The end cover of claim 11, wherein the attachment device is an insert connection.

13. The end cover of claim 12, wherein the insert connection is an insert flange projecting into an inner chamber defined by the cover housing.

14. The end cover of claim 13, wherein the insert flange is integrally connected to the covering wall.

15. The end cover of claim 13, wherein the end wall has a central area, the insert flange being integrally connected to the central area of the end wall.

16. The end cover of claim 13, wherein the cover housing further comprises a transition area which is disposed between the end wall and the covering wall and has a contact portion, the insert flange being integrally connected to the contact portion.

17. The end cover of claim 11, wherein the attachment device has at least one attachment surface.

18. The end cover of claim 17, wherein the cover housing further comprises a transition section between the end wall and the covering wall, and the at least one attachment surface is formed on the transition section.

19. A door closer comprising:
a main housing comprising two end sides; and
two end covers for covering the end sides, respectively, each of the end covers comprising:
a cover housing comprising:
a convexly curved end wall;
two opposite convexly curved lateral walls coupled to each other by the end wall; and
a flat covering wall connected to the end wall and the lateral walls;
and
an attachment device supported by the cover housing.

20. The door closer of claim 19, wherein each of the end sides having a diminished transition area for receiving the respective end cover, the diminished transition area having a counter-surface covered by the covering wall of the respective end cover, and creating an offset in an outer contour of the main housing.
